(19) United States
(12) Patent Application Publication
(10) Pub. No.: US 2001/0039515 A1
(43) Pub. Date: Nov. 8, 2001

(54) System and method for payment for targeted messaging over a network

(76) Inventor: Vijay Mayadas, Boston, MA (US)

Correspondence Address: PERKINS, SMITH & COHEN LLP, ONE BEACON STREET, 30TH FLOOR, BOSTON, MA, 02108, US

(21) Appl. No.: 09/847,796

(22) Filed: May 2, 2001

Related U.S. Application Data
(60) Provisional application No. 60/201,340, filed on May 2, 2000.

(51) Int. Cl. G06F 17/60

(52) U.S. Cl. 705/14; 705/1

(57) ABSTRACT

In the payment system of the present invention, targeted message sponsors such as advertisers pay in to the system to have the targeted message distributed according to specified parameters. Users of the system, who view the targeted messages, are compensated for interacting with the targeted message. The user data is stored in user profiles maintained by the system. Targeted message publishers are compensated for publishing the targeted messages. Data aggregators, who gather data about users for the user profiles, are compensated for the data gathered.

### CROSS-REFERENCE TO RELATED APPLICATIONS

This application claims priority of U.S. provisional applications Ser. No. 60/201,340 entitled, “System and Method for Payment for Targeted Messaging Over a Network” filed May 2, 2000 by the present applicant.

### FIELD OF THE INVENTION

This invention relates generally to payment for electronic services and more particularly to payments to a plurality of parties for targeted advertising and for user profile aggregation over the Internet.

### BACKGROUND OF THE INVENTION

People are presented with messages, including commercial advertising, almost everywhere, on television and the radio, in newspapers and magazines, on billboards, on the sides of buses and on top of taxis, and the list goes on. With so much information directed at them, people “tune out” many commercial advertisements for which vendors pay significant amounts of money to be disseminated. Further, an individual message is easily lost to an audience that sees perhaps a hundred or more advertisements every day. In order to be effective, a message must provide some hook or incentive for people to read or listen to it so that the advertisement has some impact. The problem of making an impression on a user is even more difficult in digital communications because digital media advertisements, such as banner advertisements, are easily bypassed or blocked.

Advertisement originators are interested in paying advertisement publishers only for effective advertisement as well as attracting viewers to their advertisements. Publishers of advertisements receive payment in return for publishing. Venues having a higher volume of readers or visitors generally receive higher rewards, but the payment generally is based only on estimates of the number of advertisement viewers. Under the current system of publishing advertisements, an advertisement read by one person may cost the same as an advertisement read by a thousands of people. It is desirable to pay only for those advertisements that actually reach an audience. Paying only for advertisements that actually reach an audience is a way of limiting costs to advertisement originators of ineffective advertisement campaigns. Heretofore, there has been no accurate way to compensate publishers for advertisements actually read by members of an advertisement audience. It is desirable to develop a way of rewarding publishers based on the number of advertisements read by members of the publisher's audience.

To provide a better front end targeting of potential customers, commercial entities urge potential customers to supply personal data so that customer profiles can be developed to make choices as to targeting. Web sites, for example, gather data about visitors in a variety of ways including user registrations. Users are generally not rewarded for providing this data except occasionally with some sort of “prize” or perhaps a newsletter. It is desirable to have a way of providing an incentive for potential customers to provide personal data. Further, while individual web sites may gather data about their visitors and the web sites may elect to sell that data, there is currently no systematic means of rewarding web sites for gathering and forwarding user data.

Finally, even with user profiles, a means of identifying a targeted member of an advertisement audience and a means of delivering an advertisement to that targeted member is needed. In the current art, direct mail, telemarketing, and e-mail are used in an attempt to reach a targeted audience, however, these methods are somewhat inefficient. Direct mail and e-mail may reach a target destination but the advertisements do not necessarily receive any attention from the target. It is desirable to have a method and system for delivering advertisements efficiently to a target audience and for providing some incentive for members to interact with the advertisement.

It remains desirable to have a payment system for advertisement publishing and user profile data aggregation.

It is another object of the present invention to provide a method and apparatus to have a more accurate system of rewarding advertisement publishers.

It is another object of the present invention to provide a method and apparatus for rewarding aggregators of user profile data.

It is another object of the present invention to provide a method and apparatus for attracting users to advertisements.

It is another object of the present invention to provide a method and apparatus for giving users an incentive to interact with advertisements.

It is another object of the present invention provide a method and apparatus to conduct advertisement campaigns in a more efficient and cost-effective manner.

### SUMMARY OF THE INVENTION

The problems of a payment system for advertisement publishing and user profile data aggregation are solved by the present invention of a system and method for payment for targeted advertising over a network.

In the payment system of the present invention, targeted message sponsors such as advertisers pay in to the system to have the targeted message distributed according to specified parameters. Users of the system, who view the targeted messages, are compensated for interacting with the targeted message. The user data is stored in user profiles maintained by the system. Targeted message publishers are compensated for publishing the targeted messages. Data aggregators, who gather data about users for the user profiles, are compensated for the data gathered.

In operation, a targeted message sponsor provides a targeted message, such as an advertisement, to the system for distribution. The targeted message sponsor specifies the parameters of distribution of the targeted message including the users to which the message is to be distributed. The targeted message sponsor pays in to an escrow account held by the system. The targeted message is published on one or more publishers, according to the parameters set by the message sponsor. Also, the message is published to selected users when they interact with one of the selected publishers. When a user interacts with a targeted message, such as clicking on the targeted message display, the publisher, the user, and any data aggregator involved in targeting the message are compensated from the escrow account.

The system builds user profiles from data gathered from users directly and through data aggregators with whom users interact. Users are compensated for the data they provide whether directly or through data aggregators. Data aggregators are also paid for data gathered. Data aggregators and targeted message publishers can be the same entity, such as a single web site.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of the payment system according to principles of the invention;

FIG. 2 is a flow chart of the operation of the targeted message sponsor in relation to the payment system of Figure

FIG. 3 is a flow chart of the operation of aggregating user data according to principles of the invention; and,

FIG. 4 is a flow chart of the operation of the system of FIG. 1 in distributing payments to publishers.

### DETAILED DESCRIPTION OF PREFERRED EMBODIMENTS

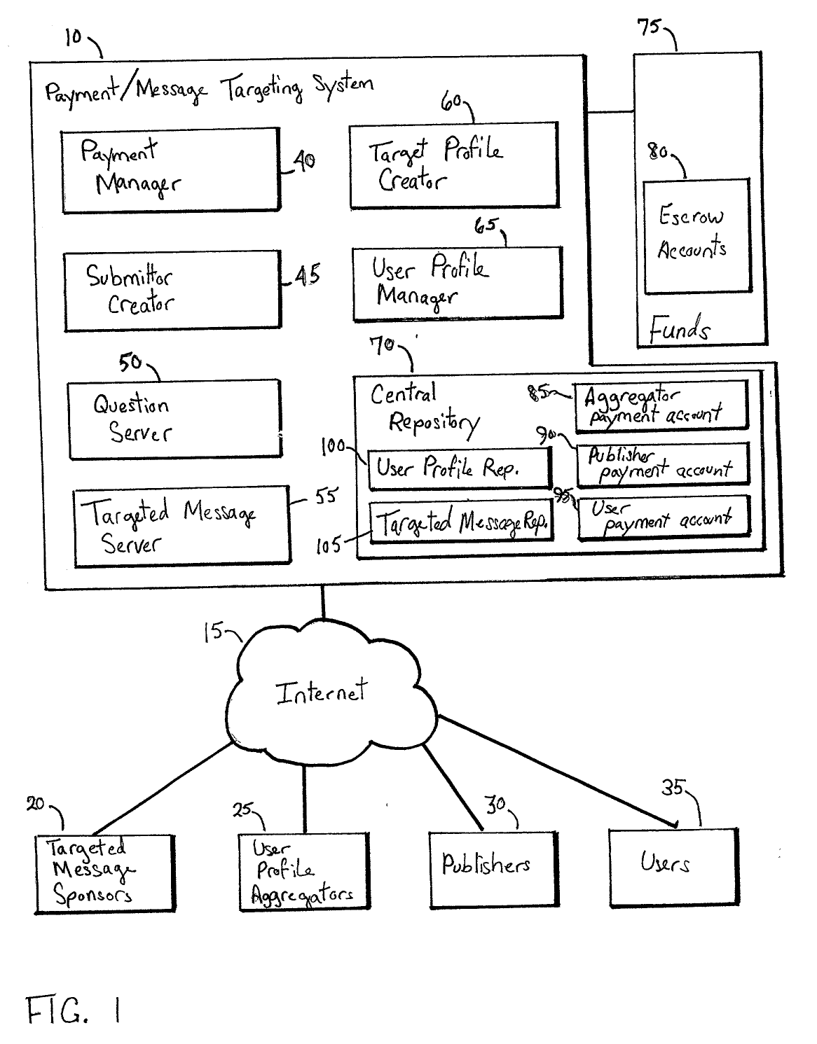

FIG. 1 is a block diagram of a payment system for a message targeting system 10 according to principles of the present invention. The payment/message targeting system 10 is connected to the Internet 15 where it is accessible to sponsors 20 of targeted messages, user profile aggregators 25, publishers 30 of targeted messages and users 35. The system 10 has a payment manager 40, a submitter creator 45, a question server 50, a targeted message server 55, a target profile creator 60, a user profile manager 65 and a central repository 70. The system 10 has a fund account 75 including escrow accounts 80. The central repository 70 has a user profile repository 100 and a targeted message repository 105. The user profile aggregators 25, publishers 30, and users 35 each have a payment accounts, 85, 90, 95 residing in the central repository 70.

The targeted message sponsors 20 send to the system 10 messages to be targeted. The targeted message sponsors send payment to the system 10 to have the targeted messages distributed according to specified parameters. One of the parameters is the selection of publishers for the targeted message. Another parameter is the type of user to whom the targeted message will be delivered. The payment is based on the number of users expected to view and interact with the targeted message. The targeted message sponsors also specify a type of interaction between the targeted message and the user. For example, in a message displayed on a web page, the sponsor specifies if the message is to be clicked on or clicked through, or some other type of interaction.

The user profile aggregators 25 present questions from the system 10 to users. The gathered data is filed in user profiles in the central repository.

The publishers receive advertisements that are distributed by the system 10. As users visit the publisher, the publisher determines whether the user is a targeted user for a particular advertisement. If the user is a targeted user, the publisher displays the advertisement. If the user performs the required action acknowledging the advertisement, the publisher is paid for delivering the advertisement. The user is also paid as are data aggregators who contributed to the user's user profile. If the user or the message sponsor was brought to the system by a data reseller, the data reseller is also paid. If the user does not interact with the advertisement in the specified manner, the publisher receives a delivery fee payment for displaying the advertisement while the user receives no payment.

The users receive payments from the system for interactions with the system either directly or indirectly through the user profile aggregators or the publishers. The users who receive payments are registered users of the system. Establishing a method of payment is generally a part of the registration process. The user may register and delay establishing a payment method in order to try out the system before making a commitment to it. Potential methods include payment directly to a bank account or a check mailed to the user. Payment may be in money or in pseudocurrency such as airline miles or points to be used on merchandise.

The users may provide personal data directly to the system to be stored in the user profile repository in the central repository. The users may also visit the user profile aggregators. The user profile aggregators present one or more questions to a visiting user. The user answers the questions and the answers are transmitted to the central repository where they are added to the user's profile. The users may also visit the publishers of targeted messages. The publishers display targeted message to the users. When the user interacts with the message, such as clicking on the message or clicking through the message, the user receives a payment from the system.

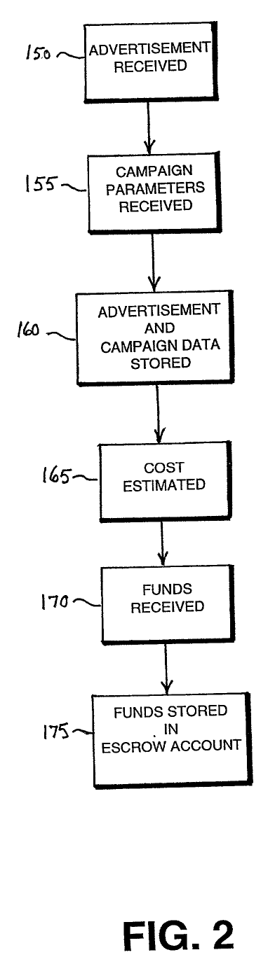

FIG. 2 shows the method of operation of a targeted message sponsor submitting a targeted message to the system using, as an example, an advertising campaign on the World Wide Web. The targeted message sponsor is an advertiser and the targeted message is an advertisement. The targeted message publishers and the user profile aggregators are web sites.

The system receives the advertisement generated and submitted by the advertiser, block 150. The advertiser establishes parameters for the advertising campaign, such as length of time, publishers or type of publisher, number of hits, group of users, etc. The system receives the parameters from the publisher, block 155. The advertisement and associated advertisement campaign data are stored in the central repository, block 160. Based on the established parameters, the cost of publishing the campaign is estimated, block 165. The system receives a block of funds from the advertiser based on the estimated cost of the advertisement campaign to the system, block 170. The block of funds from the advertiser is placed in an escrow account ready for distribution in conjunction with serving the advertisement through the web sites, block 175.

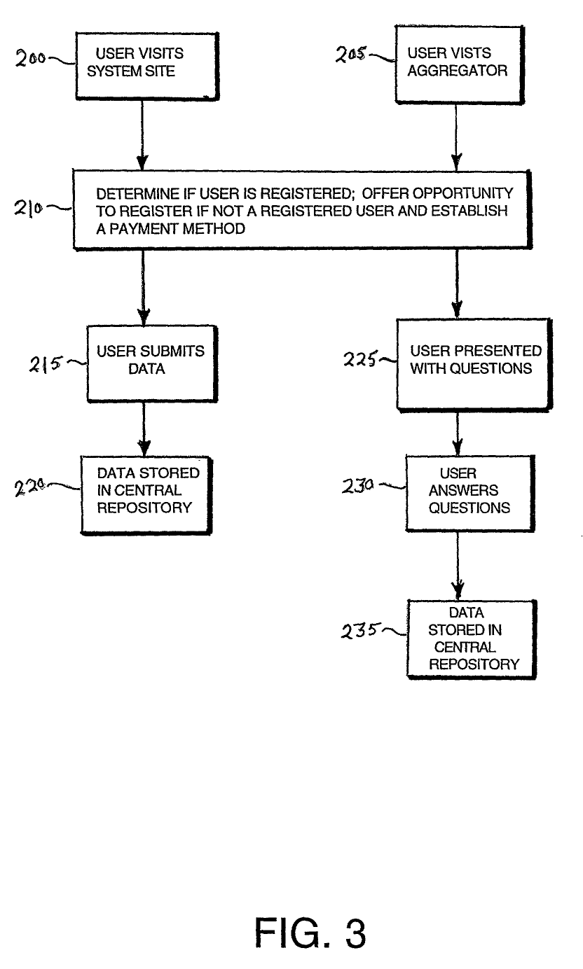

FIG. 3 is a flow chart of the data aggregation method for the stored user profiles in the system. The system maintains a database of user profiles which are used for targeting messages. Data aggregators, such as web sites, enable the gathering of user profile data. The example of the advertising campaign on the web is continued.

The user visits the system either directly by visiting the system's web site, block 200, or indirectly, by visiting a data aggregator web site associated with the system, block 205. In either case, a determination is made if the user is a registered user, block 210. This can be accomplished either through a cookie retained by the registered user or by the web site checking with the central repositories of the system. If the user is not registered, the user is given the opportunity to register. Part of the registration process can be the establishment of an account for payment for providing personal data for a user profile.

At the system site, the user may provide whatever user data the user elects, or alternatively, the system site may present a series of questions developed and stored in the central repository, block 215. The user answers the questions, and the data is stored in the user's profile in the central repository, block 220.

At a data aggregator, the registered user is presented with a series of questions as developed and delivered from the system, block 225. The user answers the questions, block 230, and the data is stored in the user profiles in the central repository, block 235.

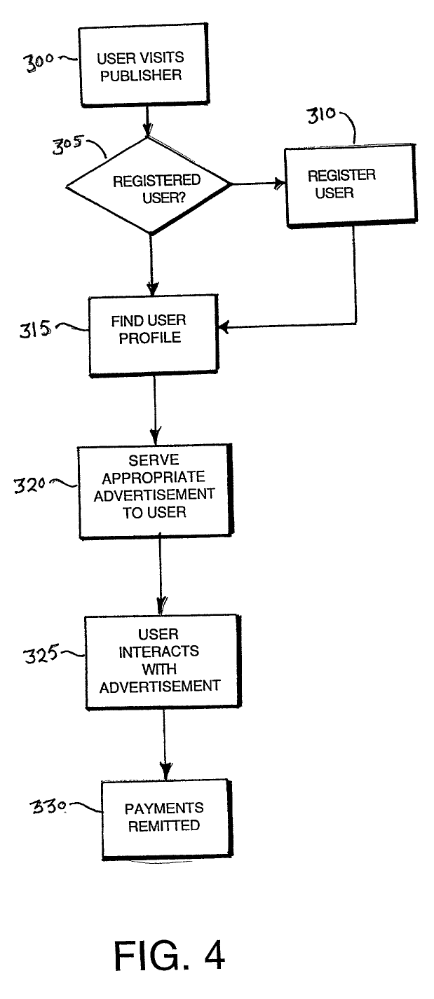

FIG. 4 is a flow chart of the operation of the system in providing payment to publishers for serving targeted messages to an audience. The example of an advertisement served at World Wide Web sites will continue to be used. The publisher is a web site and the targeted message is an advertisement.

First, a user visits a web site associated with the system that publishes advertisements from the system, block 300. The web site determines whether the user is a registered user, block 305. This can be accomplished either through a cookie retained by a registered user or by the web site checking with the system. If the user is not registered, the web site presents the user with the opportunity to register, block 310. The registration process include establishing a method of payment for the user so that the user may be provided with a payment for interacting with an advertisement.

If the user is registered, the web site checks the user's user profile in the central repository, block 315. The web site requests the central server to look at the user profiles stored in the central repository and to send back the appropriate targeted message. The advertisement sent from the central repository is served to the user, block 320.

The user may then interact with the advertisement, block 325, either by clicking on it or clicking through it to indicate that the advertisement has been seen. The user then is remitted payment for having interacted with the advertisement and the publisher is remitted payment for successfully serving the advertisement to a member of the targeted audience, block 330.

The payment system allows an advertiser to use the system with minimized risk. Advertisers place funds in an escrow account. An amount from the escrow account is paid out each time an advertisement is served. The advertiser has the opportunity to recover any unused funds if the advertisement campaign is not going as planned. In addition, the system enables easy payment from the advertiser's account into the accounts of the data aggregators and consumers using the system. If the user or the message sponsor was brought to the system by a data reseller, the data reseller is also paid.

When a user data profile is used, all parties involved in constructing the profile receive compensation. Payment is on a pay-as-used basis, so no unused data is paid for.

When an advertiser wants to send advertisements to a number of users who match predetermined profile requirements, the advertiser is charged only when those users appear. If, for example, none of them accessed any advertisement publishers during established time period an campaign, the advertiser would not be charged.

When an advertiser sets up an advertisement campaign, the advertiser gives it a maximum size: days, number of impressions, etc. The advertiser must then put funds into an escrow account to support the maximum size of campaign selected. The advertiser must also specify what type of interaction is desired in the advertisement—for example, a click through or merely a presentment for viewing. This method gives accurate feedback on the success of an advertisement campaign which in turn, provides the advertiser the means or limiting costs of an ineffective advertising campaign.

In order to receive payment from the central system, users, data aggregators and target message publishers grant access to an account of some type. This could be a regular bank account, a credit card account, or a check sent to the user or data aggregator or publisher entity. Payment could also be made in pseudocurrencies such as airline miles, or points to be used for merchandise. The system may further include the ability to convert between currencies. Once the advertiser has paid into the escrow account, the ads are served to the targeted audience.

Each time the advertisement is served and the specified action is taken by the consumer, the advertiser's escrow account is debited for the one action. Simultaneously, the accounts of the aggregators who gathered the consumer's profile information and the consumer himself or herself is credited with part of the fee.

The preferred implementation uses the Internet. In the present embodiment of the invention, advertisement service is through standard banner ads, although the process of choosing a banner is somewhat more complex for the central system of the present invention than for prior art servers. The advertisement targeting uses Java code and embedded procedures in a relational database. Alternatively, the network could be a cellular phone network or a cable television network.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A computer-implemented method for remitting payments in a targeted message system, comprising the steps of:
publishing information from a targeted message sponsor at an access point provided by a publisher on a network connected to the targeted message system; and
providing a first payment to the publisher of said information in response to user interaction with said published information at said access point.

2. The method of claim 1 further comprising the steps of
determining if a user interacting with said published information is a qualified user; and
if said user is qualified, providing a second payment to said qualified user in response to said user interaction.

3. The method of claim 2 wherein said step of determining whether said user is qualified further comprises determining whether said user has a user profile in the targeted message system.

4. The method of claim 3 wherein said step of determining whether said user is qualified further comprises the step of determining whether said user profile matches a target profile associated with said published information.

5. The method of claim 1 wherein the step of publishing information further comprises publishing a targeted message.

6. The method of claim 1 wherein said targeted message is an advertisement.

7. The method of claim 1 wherein the step of publishing information further comprises publishing at least one query to be answered by a user.

8. The method of claim 1 wherein said network is the Internet.

9. The method of claim 2 further comprising the steps of:
receiving funds from a targeted message sponsor;
maintaining said funds in an escrow account associated with the targeted message system;
providing said first and said second payments from said escrow account.

10. A targeted message payment system, comprising:
an information server to send information from a targeted message sponsor and to receive a response from a user to said information, said server to serve said information at a user access point of a network; and
a payment server to remit a payment to said user access point in response to said user response.

11. The system of claim 10, further comprising,
a user profile manager to determine whether said user has a user profile in a profile repository of the targeted message system, the payment server to pay the user in response to said user response if said user has a user profile.

12. The system of claim 11 wherein said information server is a targeted message server to serve a targeted message to a publisher based on said user's profile and a target profile associated with said targeted message.

13. The system of claim 11 wherein said information server is a question server and said user access point is a user profile aggregator, said question server to serve questions to said user, said user profile aggregator to return user responses to the targeted message system to be stored in said user's user profile.

14. The system of claim 10 further comprising a funds account having funds for payment from the targeted message sponsor.
